(19) United States
(12) Patent Application Publication
(10) Pub. No.: US 2026/0023960 A1
(43) Pub. Date: Jan. 22, 2026

(54) MIXED-SIGNAL DESIGN TECHNIQUES FOR NEUROMORPHIC COMPUTING

(71) Applicant: Newton Howard, Potomac, MD (US)

(72) Inventor: Newton Howard, Potomac, MD (US)

(21) Appl. No.: 19/012,847

(22) Filed: Jan. 7, 2025

Related U.S. Application Data
(60) Provisional application No. 63/618,504, filed on Jan. 8, 2024.
(60) Provisional application No. 63/566,327, filed on Mar. 17, 2024.
(60) Provisional application No. 63/566,831, filed on Mar. 18, 2024.

(51) Int. Cl. G06N 3/063

(52) U.S. Cl. CPC G06N 3/063

(57) ABSTRACT

A system may comprise hardware and software configured to perform computing functions that mimic at least one computing function of a human brain, wherein the hardware and software comprises: analog circuitry configured to perform signal processing of neural signals obtained from living brain tissue using at least one sensor, a computer system comprising a processor, memory accessible by the processor, and computer program instructions stored in the memory and executable by the processor digital circuitry and software configured to process the obtained neural signals to generate a representation of a brain function from the obtained neural signals, and to generate parameters for use by analog and digital circuitry to perform computing functions that mimic at least one computing function of a human brain, and the analog and digital circuitry configured to use the generated parameters to perform computing functions that mimic at least one computing function of a human brain.

### CROSS-REFERENCE TO RELATED APPLICATIONS

This application claims the benefit of U.S. Provisional Application No. 63/618,504, filed Jan. 8, 2024, U.S. Provisional Application No. 63/566,327, filed Mar. 17, 2024, and U.S. Provisional Application No. 63/566,831, filed Mar. 18, 2024, the contents of all of which are incorporated herein in their entirety.

### BACKGROUND

The present invention relates to mixed signal techniques for neuromorphic computing

Neuromorphic computing, a paradigm inspired by the neural structures and computational processes of the human brain, has seen considerable evolution since its inception. Tracing its origins to Hebb's concept of synaptic plasticity as a mechanism for learning and memory, it forms the foundation of modern neuromorphic computing. The term “neuromorphic computing” was coined by Carver Mead in the late 1980s, marking a significant departure from traditional von Neumann architecture and leading to the development of the first neural-inspired chips like artificial retinas and cochleas using analog VLSI circuits.

In recent years, neuromorphic computing has expanded to include various implementations in software and hardware, including digital, analog, and mixed-signal circuits. This expansion is propelled by substantial research initiatives, such as the DARPA SYNAPSE program, fostering advancements in memristors, silicon neurons, and synapse models. Key developments in neuromorphic architectures include IBM's TrueNorth and Intel's Loihi, showcasing principles of plasticity and learning. Additionally, there is a growing exploration of optical “memristors” as potential key components for developing high-bandwidth and efficient neuromorphic machine learning hardware, which represents a recent and significant advancement in the field.

Accordingly, a need arises for design techniques that proved improved performance over existing techniques.

### SUMMARY

Embodiments of the present systems and methods may provide design techniques that proved improved performance over existing techniques. For example, neuromorphic systems excel in parallel processing, event-driven computation, and exhibit synaptic plasticity mechanisms like spike-timing-dependent plasticity (STDP), enhancing pattern recognition and sensory data processing. These systems are scalable and incorporate elements of stochasticity, reflecting the probabilistic nature of biological neural networks. Brain Code Unit (BCU) and Fundamental Code Unit (FCU) are neuromorphic core of our proposed neuromorphic computing implementation. BCU is designed to mimic the brain's ability to encode and process information, while FCU serve as the fundamental building blocks for these operations. Together, they form the basis of neuromorphic systems, enabling them to replicate complex neural processes. Understanding these units is crucial for advancing neuromorphic computing and utilizing its full potential. Mixed-signal design, which involves the integration of both analog and digital circuitry, plays a crucial role in the advancement of neuromorphic systems. This approach leverages the precision and flexibility of digital systems along with the robustness and energy efficiency of analog systems. Mixed-signal design holds the potential to significantly enhance the performance of neuromorphic computing architectures, particularly in terms of scalability, power efficiency, and the ability to handle a wide range of computational tasks. The landscape of neuromorphic computing is diverse, encompassing both digital and analog architectures. Digital neuromorphic systems, known for their precision and programmability, have been extensively explored and applied in various computational tasks. They simulate neural processes using discrete digital signals, offering a high degree of control and reproducibility. On the other hand, analog neuromorphic architectures attempt to more closely mimic the analog nature of biological neural networks. These systems are characterized by their energy efficiency and real-time processing capabilities, making them particularly suited for tasks that require natural, continuous data processing.

For example, in an embodiment, a method to perform computing functions that mimic at least one computing function of a human brain may comprise performing signal processing of neural signals obtained from living brain tissue using at least one sensor using analog circuitry, processing the obtained neural signals to generate a representation of a brain function from the obtained neural signals, and to generate parameters for use by analog and digital circuitry to perform computing functions that mimic at least one computing function of a human brain using a computer system comprising a processor, memory accessible by the processor, and computer program instructions stored in the memory and executable by the processor digital circuitry and software configured to process the obtained neural signals to generate a representation of a brain function from the obtained neural signals, and to generate parameters for use by analog and digital circuitry to perform computing functions that mimic at least one computing function of a human brain, and using the generated parameters to perform, using analog and digital circuitry, computing functions that mimic at least one computing function of a human brain.

In embodiments, the analog and digital circuitry may be configured to perform computing functions using Brain Code Units and Fundamental Code Units. The method may further comprise processing the obtained neural signals to generate a representation of a brain function from the obtained neural signals, and to generate parameters for use by analog and digital circuitry to perform computing functions that mimic at least one computing function of a human brain using Image and Audio data, Disorder Signature data, and Neuroscience Expression data. The method of may further comprise using the generated parameters to perform, using analog and digital circuitry, computing functions that mimic at least one computing function of a human brain using Image and Audio data, Disorder Signature data, and Neuroscience Expression data.

In an embodiment, a system may comprise hardware and software configured to perform computing functions that mimic at least one computing function of a human brain, wherein the hardware and software comprises: analog circuitry configured to perform signal processing of neural signals obtained from living brain tissue using at least one sensor, a computer system comprising a processor, memory accessible by the processor, and computer program instructions stored in the memory and executable by the processor digital circuitry and software configured to process the obtained neural signals to generate a representation of a brain function from the obtained neural signals, and to generate parameters for use by analog and digital circuitry to perform computing functions that mimic at least one computing function of a human brain, and the analog and digital circuitry configured to use the generated parameters to perform computing functions that mimic at least one computing function of a human brain.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary illustration of differential encoding of abstract mathematical rules according to the present systems and methods.

FIG. 2 is an exemplary Overview of a brain-like computing paradigm according to the present systems and methods.

FIG. 3 is an exemplary block diagram of Integration of Fundamental Code Unit (FCU) and Brain Code Unit (BCU) in Neuromorphic Systems according to the present systems and methods.

FIGS. 4a and 4b are an exemplary block diagram of an overall architecture of a system, according to embodiments of the present systems and methods.

FIGS. 5a, 5b, 5c, and 5d present exemplary results of performance of embodiments of the present systems and methods across three distinct hardware platforms using various datasets.

FIG. 6 is an exemplary block diagram of a computer system, in which processes involved in the embodiments described herein may be implemented.

### DETAILED DESCRIPTION

Embodiments of the present systems and methods may provide design techniques that proved improved performance over existing techniques. For example, neuromorphic systems excel in parallel processing, event-driven computation, and exhibit synaptic plasticity mechanisms like spike-timing-dependent plasticity (STDP), enhancing pattern recognition and sensory data processing. These systems are scalable and incorporate elements of stochasticity, reflecting the probabilistic nature of biological neural networks. Brain Code Unit (BCU) and Fundamental Code Unit (FCU) are neuromorphic core of our proposed neuromorphic computing implementation. BCU is designed to mimic the brain's ability to encode and process information, while FCU serve as the fundamental building blocks for these operations. Together, they form the basis of neuromorphic systems, enabling them to replicate complex neural processes. Understanding these units is crucial for advancing neuromorphic computing and utilizing its full potential. Mixed-signal design, which involves the integration of both analog and digital circuitry, plays a crucial role in the advancement of neuromorphic systems. This approach leverages the precision and flexibility of digital systems along with the robustness and energy efficiency of analog systems.

Neuromorphic systems excel in parallel processing, event-driven computation, and exhibit synaptic plasticity mechanisms like spike-timing-dependent plasticity (STDP), enhancing pattern recognition and sensory data processing. These systems are scalable and incorporate elements of stochasticity, reflecting the probabilistic nature of biological neural networks.

Brain Code Unit (BCU) and Fundamental Code Unit (FCU) are neuromorphic core of our proposed neuromorphic computing implementation. BCU is designed to mimic the brain's ability to encode and process information, while FCU serve as the fundamental building blocks for these operations. Together, they form the basis of neuromorphic systems, enabling them to replicate complex neural processes. Understanding these units is crucial for advancing neuromorphic computing and utilizing its full potential. Mixed-signal design, which involves the integration of both analog and digital circuitry, plays a crucial role in the advancement of neuromorphic systems. This approach leverages the precision and flexibility of digital systems along with the robustness and energy efficiency of analog systems.

Mixed-signal design holds the potential to significantly enhance the performance of neuromorphic computing architectures, particularly in terms of scalability, power efficiency, and the ability to handle a wide range of computational tasks.

The landscape of neuromorphic computing is diverse, encompassing both digital and analog architectures. Digital neuromorphic systems, known for their precision and programmability, have been extensively explored and applied in various computational tasks. They simulate neural processes using discrete digital signals, offering a high degree of control and reproducibility. On the other hand, analog neuromorphic architectures attempt to more closely mimic the analog nature of biological neural networks. These systems are characterized by their energy efficiency and real-time processing capabilities, making them particularly suited for tasks that require natural, continuous data processing.

Brain Code Unit (BCU) and Fundamental Code Unit (FCU). The development of Brain Code Unit (BCU) and Fundamental Code Unit (FCU) proposed by Newton Howard and Amir Hussain represents a significant advancement in neuromorphic computing aiming to provide a better modeling of the brain's computational processes and enabling the design of more efficient and effective neuromorphic systems. BCU focus on modeling complex decision-making processes, while FCU aim to quantify intelligent thought processes at various analytical levels from the linguistic and behavioral output to the chemical and physical processes within the brain, contributing to a more detailed understanding and simulation of brain functionality.

Mixed-Signal Design in Neuromorphic Systems. Mixed-signal design, crucial in neuromorphic computing, integrates analog and digital circuitry. It combines digital systems' flexibility with the robustness and energy efficiency of analog processing. BCU and FCU benefit from this approach through reduced latency, increased computational speed, and enhanced system robustness and adaptability.

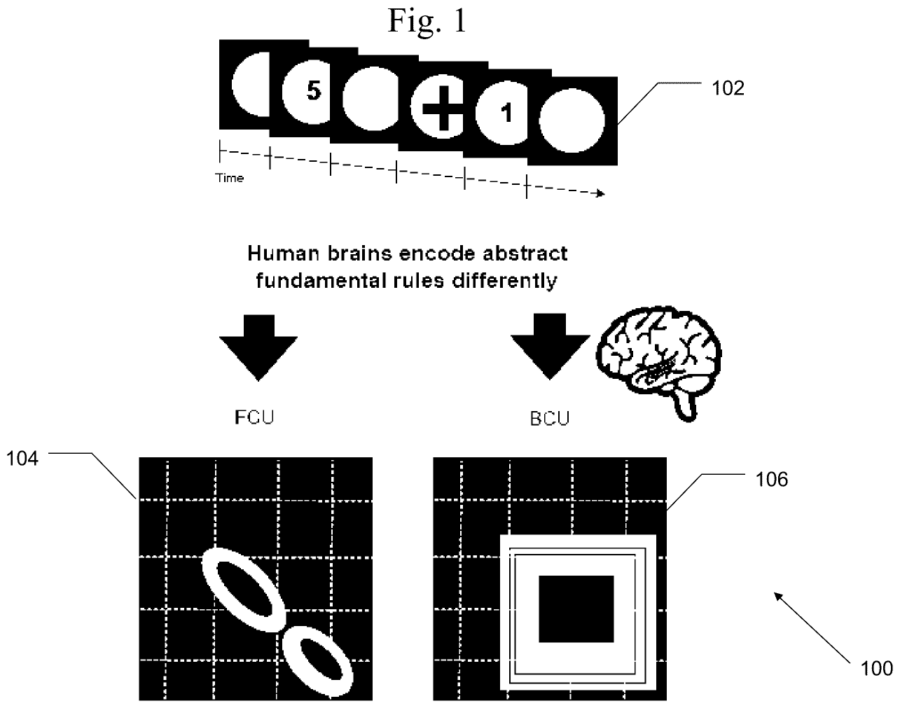

FIG. 1 illustrates Differential Encoding of Abstract Mathematical Rules in Humans 100. This figure illustrates the contrast between dynamic coding in the parahippocampal cortex and static coding in the hippocampus. The top panel depicts the sequence of abstract operations over time 102, linked to distinct neural activities. On the bottom left, dynamic coding 104 is visualized as shifting activity patterns corresponding to different abstract rules. Conversely, the bottom right heatmap 106 demonstrates static coding with consistent activation regions irrespective of changes in abstract rules. This indicates a division of labor within the human medial temporal lobe in the processing of abstract information, with implications for understanding the neural basis of high-level cognition.

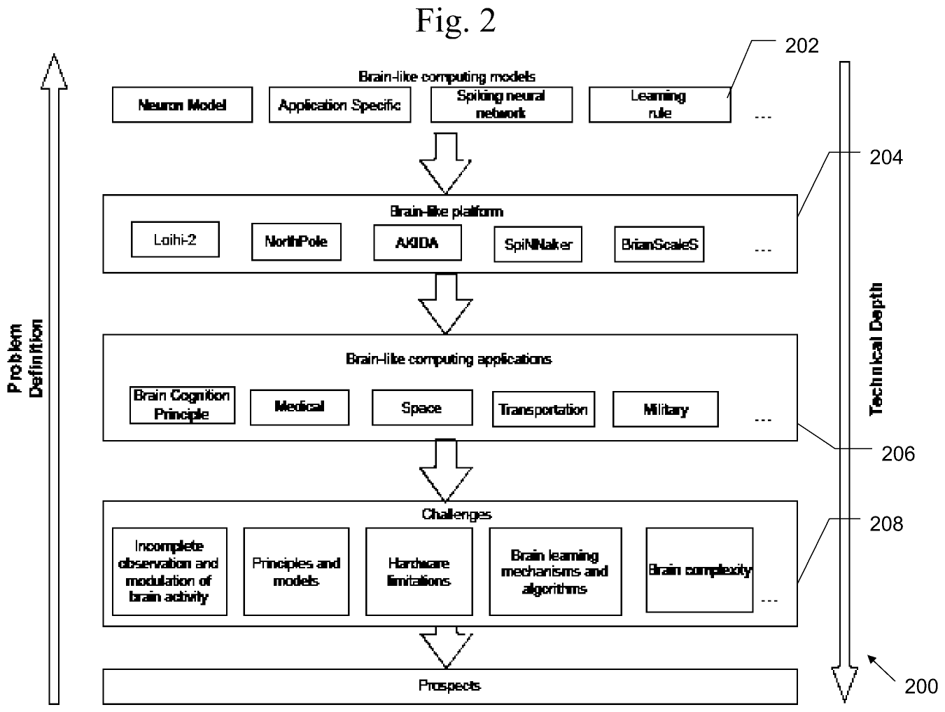

FIG. 2 illustrates the hierarchy of components in brain-like computing with an Overview of Brain-like Computing Paradigm 200. This starts with foundational concepts at the neuron model level and peaking in practical applications. It outlines the progression from neuron models and spiking neural networks 202, through platforms designed to mimic brain functions 204, to specific applications in various fields such as medical, space, and military 206. The diagram also highlights the challenges 208 faced in the development of these technologies, including hardware limitations and the complexity of brain learning mechanisms and algorithms. Prospects for future development are indicated, suggesting areas for further research and potential breakthroughs.

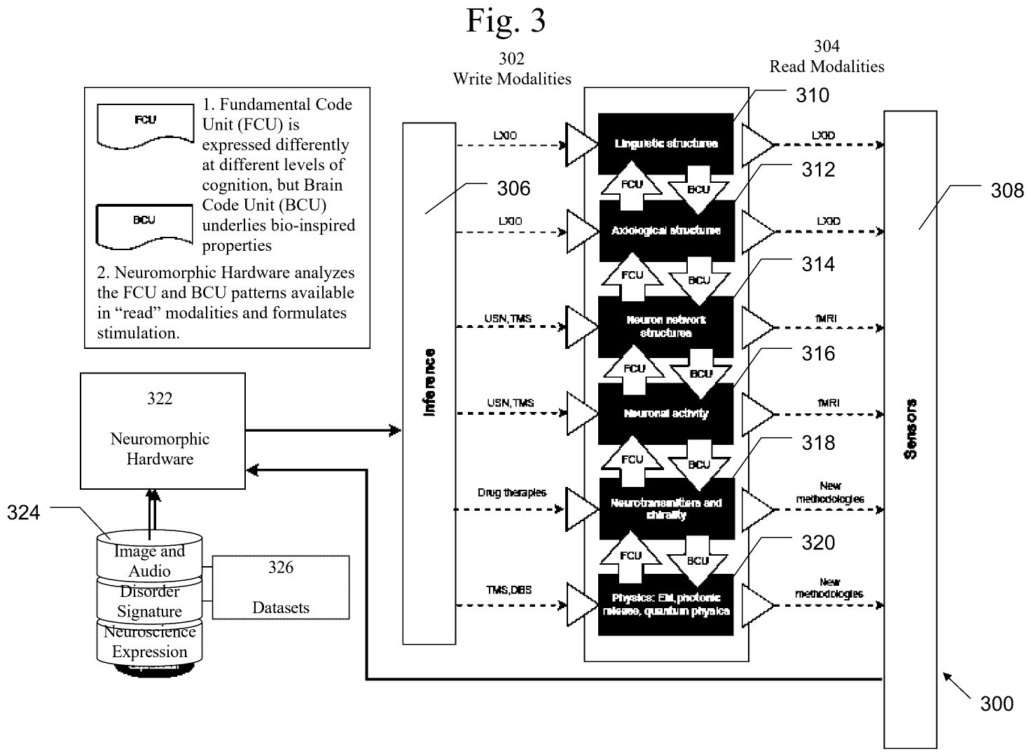

DESIGN METHODOLOGY. FIG. 3 illustrates Integration system 300 of Fundamental Code Unit (FCU) and Brain Code Unit (BCU) in Neuromorphic Systems. This shows the intricate interplay between linguistic and axiological structures, neurotransmitter chirality, and neuron network structures. It details how these elements influence neuronal activity and are represented in various modalities such as image, audio, and neuroscience expressions. The diagram shows the incorporation of neuromorphic hardware and inference mechanisms to process and analyze these representations. The FCU and BCU are depicted as foundational elements, operating at different cognitive levels and interfacing with read and write modalities. The neuroscientific methodologies, including fMRI, TMS, and DBS, are mapped to specific aspects of the FCU and BCU, highlighting their roles in understanding and addressing neural disorders. The figure underscores the comprehensive approach of neuromorphic systems in capturing, processing, and utilizing complex neural information for advanced computing and medical applications.

As shown in FIG. 3, Integration system 300 may include Write modalities 302 and Read modalities 304. Write modalities 302 may include Write interface 306, and read modalities 304 may include sensors 308. Processing structures may include linguistic processing structures 310, axiological processing structures 312, neuron network processing structures 314, neuronal activity processing 316, neurotransmission and chirality processing 318, and physics: EM, photonic release, and quantum physics processing. Neuromorphic hardware 322, embodiments of which are further described herein, may connect to write interface 306 and sensors 308. Further, neuromorphic hardware 322 may connect to databases 324 and data sets 326. Databases 324 may include image and audio databases, disorder signature databases, and neuroscience expression databases. Write interface 306 may interface with processing structures using protocols such as LXIO, USN, TMS, drug therapies, and DBS. Sensors 308 may interface with processing structures using protocols such as LXIO, fMRI and other methodologies.

Integration Techniques for BCUs and FCUs. A key aspect of our methodology is the integration of BCUs and FCUs into the digital architecture. This section will describe the techniques used to embed these units into the neuromorphic system. It will detail how BCU and FCU interact within the architecture, their role in data processing and neural emulation, and the methods used to optimize their efficiency and effectiveness. In our exploration of Mixed-signal neuromorphic systems using BCU and FCU, we have identified several relevant open-source datasets 326. For BCU, we focus on datasets that provide insights into neural activity and brain signaling processes. BrainMRI dataset offers valuable information on brain activity patterns which are crucial for simulating brain-like information processing. These datasets are integral to our methodology, allowing us to rigorously evaluate the performance and efficiency of our proposed neuromorphic architecture across various computational tasks.

Brain Code Unit (BCU). We delineate the construction of a BCU leveraging spiking neural network (SNN) paradigms for the classification of Magnetic Resonance Imaging (MRI) scans of the brain. The proposed BCU is architected to harness the computational prowess of CUDA-enabled Graphical Processing Units (GPUs) to expedite parallel processing, thereby augmenting efficiency.

Data Handling. The BrainMRI dataset class is a signify subclass of the dataset module within PyTorch, tailored for the management of brain MRI datasets. It amasses file paths and their associated binary labels, representing the presence or absence of tumors, and facilitates index-based retrieval of individual data points.

Preprocessing. We define a suite of transformations to standardize the images, employing the transforms module in PyTorch. This preprocessing pipeline includes resizing images to uniform dimensions, tensor conversion, and pixel value normalization, crucial for optimizing the learning efficacy of the network. The dataset is bifurcated into training and testing partitions, and data loaders are instantiated to administer batch-wise data handling and shuffling during the training phase. The neural composition of the BCU is encapsulated within the SNN class, which comprises a convolutional layer succeeded by a custom LIFNeuron layer. The LIFNeuron simulates the Leaky Integrate-and-Fire neuron, a quintessential component of biological neural networks, to mimic the temporal dynamics intrinsic to spiking neurons. The training regimen iterates across designated epochs, within which the model parameters are refined via the Adam optimization algorithm, paired with a cross-entropy loss function to assess performance. Post each epoch, the model's predictive accuracy on the training and testing datasets is evaluated in a non-gradient update mode (inference mode) to monitor and gauge learning progression. Upon the peak of training, the model parameters are preserved to the storage medium, facilitating subsequent retrieval for analysis or deployment in predictive tasks. The model summarizes the core logic of the BCU, explaining the synergy between computational models and neural dynamics.

DEVELOPMENT OF A FUNDAMENTAL CODE UNIT FOR ARITHMETIC LOGIC OPERATIONS. This manuscript details the construction of FCU that is architected to perform arithmetic logic operations within the framework of SNNs, leveraging the computational efficiency of CUDA-enabled GPUs.

Data Acquisition and Preprocessing. The CIFAR-10 dataset, comprising a rich repository of labeled imagery, serves as the training and testing ground for the FCU. The dataset undergoes a normalization process, crucial for enhancing the convergence rate during the learning process. The LIFNeuron module, integral to the FCU, encapsulates the dynamics of a Leaky Integrate-and-Fire (LIF) neuron. It simulates the bio-physiological processes of neuronal spike generation and membrane potential resetting, which are pivotal for the temporal dynamics of spiking neurons. The FCU is instantiated as an SNN, incorporating convolutional layers for feature extraction from input images, followed by Leaky Integrate-and-Fire neurons to introduce temporal dynamics. The output is subsequently flattened and processed through a linear layer for classification. A training loop is devised to fine-tune the FCU across several epochs, employing backpropagation with the Adam optimizer and a cross-entropy loss criterion. The FCU's performance is periodically evaluated on both training and testing sets to monitor the progression of learning accuracy. Upon the completion of the training epochs, the FCU state is conserved onto the disk, enabling future retrieval for inferential applications or further refinement. The model encapsulates the quintessence of the FCU, showcasing the interplay between neural dynamics and computational efficiency for the execution of arithmetic logic operations.

Description of the Digital Neuromorphic Architecture. Our methodology begins with a detailed description of the proposed digital neuromorphic architecture. This includes an outline of its structural design, computational models, and the processes it emulates. The architecture's core components, data processing pathways, and neural network emulation techniques are discussed to provide a comprehensive understanding of the system's functionality. We have successfully deployed the architectures of the FCU and BCU on GPUs using the Python programming environment. A normalization process was applied, focusing on accuracy metrics, to ensure the robustness of the computational model. Subsequently, the research progressed towards the realm of digital design. In this phase, we have harnessed the capabilities of Verilog hardware description language to execute preliminary simulations of the FCU and BCU designs on an XCZU7EV FPGA Chip, housed within the ZCU-104 evaluation board. These designs were verified on testbench within same datasets. The scalability of our architecture was evaluated by varying the size and complexity of the neural networks it emulated, thereby demonstrating its adaptability to diverse computational tasks. Furthermore, we have conducted a comparative analysis with extant neuromorphic architectures, underscoring the distinctive features and benefits of our approach. Despite encountering certain limitations and challenges, which we transparently discuss, we have outlined strategies to explain these obstacles in future iterations of our design.

Mixed-Signal Design Approach and Materials Used. The final part of the methodology focuses on the Mixed-signal design approach. This involves integrating analog and digital components to enhance the system's performance. The section will elaborate on the selection of materials and components, the rationale behind their choice, and how they contribute to the overall functionality of the neuromorphic system. Particular attention will be given to the design choices that enable the system to efficiently process complex neural computations. The intricacies of integrating analog and digital domains are addressed through a mixed-signal design methodology. In this approach, the pivotal connection between the analog and digital components is facilitated via an analog-to-digital converter (ADC) and a digital-to-analog converter (DAC). These converters interface with the system's logic through a Serial Peripheral Interface (SPI), a protocol selected for its robustness and high-speed data transfer capabilities. The ADC component is crucial in translating continuous analog signals, such as those emanating from environmental sensors, into a discretized digital representation. This digital form is flexible to processing by the subsequent digital logic circuits coded in Verilog. Our design leverages the ADC's precision to ensure reliability in capturing the nuances of the analog input. Conversely, the DAC serves as a bridge in the opposite direction. It takes digital signals, which are the outcomes of VHDL logic computations, and transforms them into analog signals. These analog outputs can then drive actuators, enabling the system to interact with its physical surroundings. The DAC's accuracy is paramount in ensuring that the digital decisions are accurately reflected in the real world.

To implement this mixed-signal approach, we selected high-quality components that are compatible with the board's specifications. The choice of materials was informed by a series of criteria, including signal integrity, conversion rate, resolution, and power consumption. The SPI interface pins on the board were meticulously defined to align with the electrical characteristics and timing requirements of the ADC and DAC. Additionally, the design incorporates protective circuitry to guard against common pitfalls in mixed-signal environments, such as noise coupling and signal interference. By adopting a mixed-signal design, we integrate the analog richness of natural signals with the computational power of digital systems, thus broadening the applicability of our neuromorphic architecture to interact with a wide range of sensors and actuators in a diverse array of environments.

Chip Layout with RTL to GDSII Flow. The process of transforming high-level architectural descriptions of the FCU and BCU into a manufacturable chip layout has been meticulously executed via a Register-Transfer Level (RTL) to Graphic Data System II (GDSII) flow. Utilizing OpenLane, an automated RTL to GDSII flow suite that is designed to produce high-quality layouts, we were able to translate our Verilog code into a physical form factor compatible with silicon fabrication norms. OpenLane arranges the intricate progression from Verilog code to a physical layout by automating the various steps involved in the process. This synthesis, where the Verilog code is converted into a gate-level netlist using logic gates and other standard cells. Following this, floorplanning establishes the chip's initial spatial configuration, defining the location of logic blocks and ensuring optimal area utilization and power distribution. The subsequent phase of placement optimizes the positioning of the standard cells within the floorplan's constraints, aiming to minimize delays and signal integrity issues. This is followed by routing, where electrical connections between the components are made, taking into account the intricate web of design rules and constraints. Throughout this progression, OpenLane employs rigorous design rule checks (DRC) and layout versus schematic (LVS) checks to ensure that the resulting layout is free from violations and accurately reflects the original schematic. This verification is crucial, as it guarantees the manufacturability of the design and its functionality post-fabrication. Additionally, parasitic extraction is performed to model the unwanted resistive, capacitive, and inductive effects that arise from the physical layout. These are significantly influence the chip's performance, and their early consideration is vital for high-frequency applications typical of neuromorphic computing architectures. Once the GDSII file is generated, signifying the completion of the RTL to GDSII flow, it can be sent to a foundry for fabrication. The GDSII file contains all the geometric shapes, layer information, and design required to manufacture the physical integrated circuit. This process is evidence of the synergy between computational logic design and physical implementation, bridging the gap between neuromorphic concepts and tangible, real-world applications. By leveraging OpenLane's capabilities, we have ensured that the FCU and BCU are not only theoretically sound but are also poised for successful integration into hardware platforms.

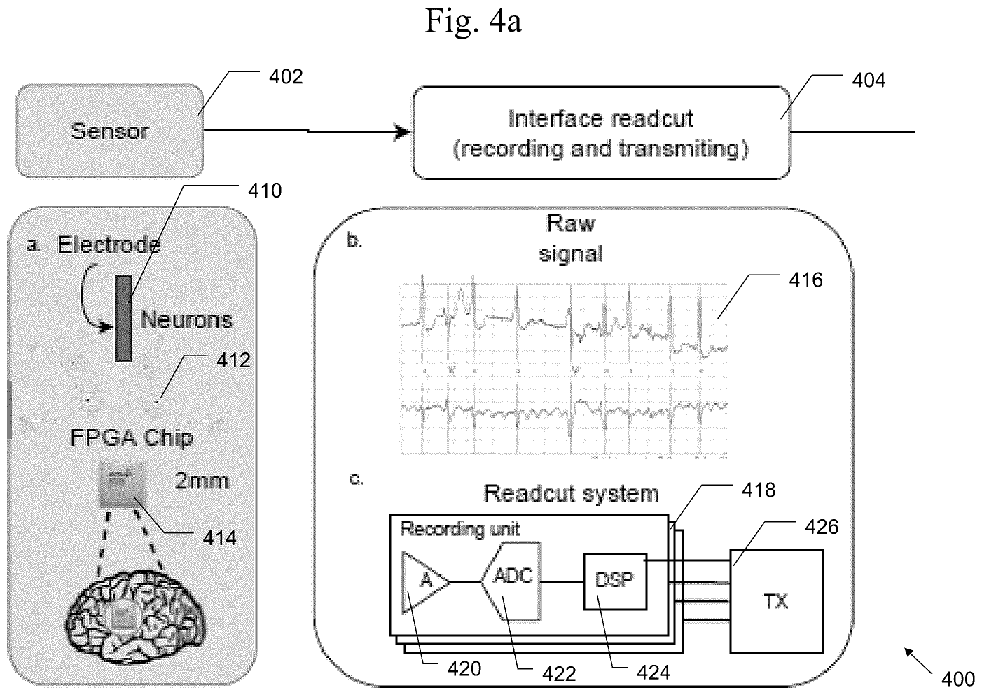

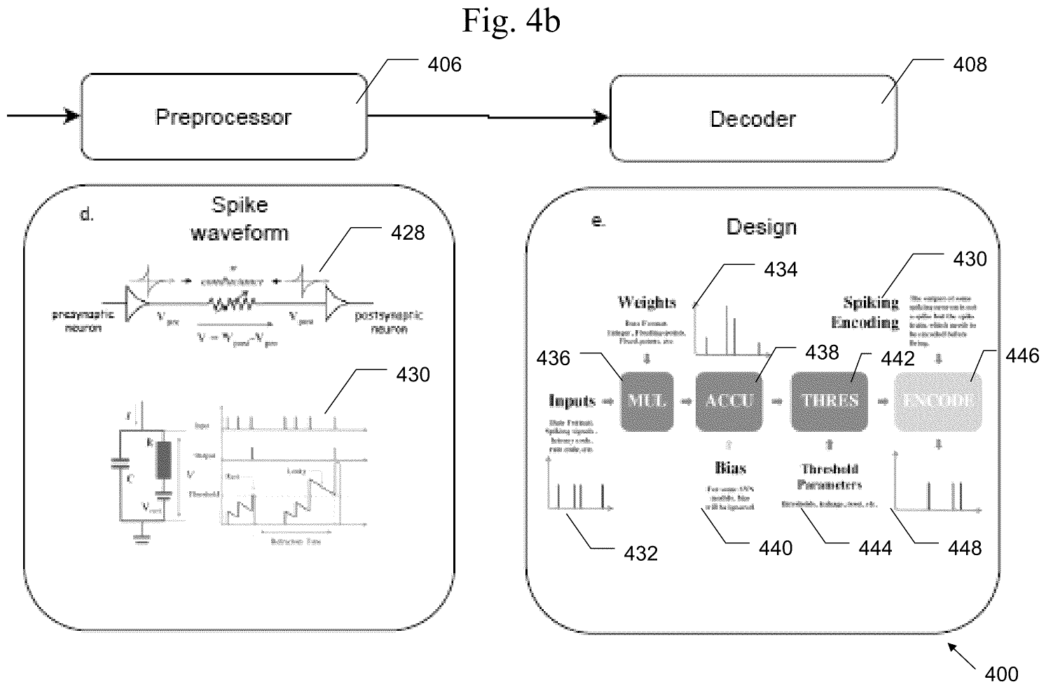

FIGS. 4a and 4b illustrate a Block Diagram of Implementation of an embodiment of the present systems and methods. These figures presents a detailed depiction of a neuromorphic system architecture 400, focusing on the integration of neural signal processing with digital computing. System 400 may include sensors 402, interface readout 404, preprocessor 406, and decoder 408. Sensors 402 may include electrodes 410 in electrical and/or optical communication with neurons 412. Initial signal conditioning and processing of neural signals obtained, for example, from living brain tissue using sensors 402, for example, using analog circuitry, which may be discrete circuitry, or may analog circuitry contained in a mixed signal Field Programmable Gate Array chip 414. Central to this illustration is an FPGA chip 414, signifying its crucial role in neural data interpretation. The figures encompasses several key components: the interface between the FPGA chip 414 and neurons 412 via an electrode array 410, suggesting a direct connection for signal acquisition and sensor systems 402 for raw neural signal capture. Interface readout 404 may perform recording and transmission of signals 416 received from sensors 402.

Interface readout 404 may accept raw or processed signals 416 and process the signals using readout system 418, including a combination of, for example, analog circuitry, ADC 422, DSP 424, and TX 426 modules for signal conversion, processing, and transmission. Additional signal processing of the neural signals may be performed using this analog and digital circuitry.

Preprocessor 406 may perform analysis of neural spike waveforms 428, a fundamental aspect of neural communication. This may be done to generate a representation of a brain function from the obtained neural signals, and to generate parameters for use by analog and digital circuitry to perform computing functions that mimic at least one computing function of a human brain. Such processing may be performed, for example, using a computer system comprising a processor, memory accessible by the processor, and computer program instructions stored in the memory and executable by the processor digital circuitry and software configured to process the obtained neural signals to generate a representation of a brain function from the obtained neural signals, and to generate parameters for use by analog and digital circuitry to perform computing functions that mimic at least one computing function of a human brain. Additionally, the preprocessor 406 and design decoder 408 elements indicate advanced stages of signal conditioning and interpretation 430, 432, translating neural activities into actionable data. For example decoder 432 may accept inputs 432 including date format, spiking signals, latency code, rate code, et cetera, along with weights 434, and may multiplex 436 inputs 432 and weights 434 to form weighted data, which may be biased 440 in accumulator 438 (for some SSN models, bias may be ignored). The data from accumulator 438 may be thresholded 442 using threshold parameters 444, such as thresholds, leakage, reset, etc., then encoded 446 to form output data 448. Output data 448 may include representations of the output of spiking neurons. Thus, the generated parameters may be used to perform, using analog and digital circuitry, computing functions that mimic at least one computing function of a human brain. The output of some spiking neurons is not a spike, but a spike train, which needs to be encoded before firing. Collectively, the figures exemplifies the fusion of biological neural signals with state-of-the-art digital processing, illustrating a holistic approach to harnessing neural information for computational and neuroscientific advancements.

EVALUATION. This section presents the findings from the experiments conducted using the neuromorphic system. It includes a detailed analysis of the system's performance based on the opensource datasets. The results are quantified in terms of accuracy, processing speed, power efficiency, and other relevant metrics. The final part of the experimental setup defines the criteria used to evaluate the performance of the neuromorphic system. This involves outlining the benchmarks and metrics used to assess the system's accuracy, efficiency, and overall effectiveness. The criteria reflects the objectives of the research, ensuring that the system's performance is evaluated in a comprehensive and objective manner.

TABLE I
RESOURCE UTILIZATION SUMMARY
FOR BCU AND FCU IMPLEMENTATIONS
Zynq UltraScale + XCZU7EV

| | BCU | % Uti- | FCU | % Uti- | |
|---|---|---|---|---|---|
| | Uti- | lization | Uti- | lization | |
| Resource | lization | (BCU) | lization | (FCU) | Available |
| LUT | 151,200 | 30 | 140,000 | 27.78 | 504,000 |
| Memory | 11.4 MB | 30 | 10.5 MB | 27.63 | 38 MB |
| IO | 139 | 29.19 | 130 | 28.02 | 464 |
| DSP | 518 | 29.94 | 480 | 27.78 | 1,728 |

Table I presents a comprehensive summary of resource utilization for both the BCU and FCU implementations. This summary was compiled using the Zynq UltraScale+ XCZU7EV platform as the benchmark. The table delineates the specific resources utilized, including Look-Up Tables (LUTs), Memory, Input/Output (IO) interfaces, and Digital Signal Processors (DSPs). For each resource, we provide a dual comparison: one for the BCU and another for the FCU. The utilization figures are presented in absolute terms and as a percentage of the total available resources on the platform. This dual presentation allows for an immediate grasp of the scale and efficiency of the resource usage. Specifically, the LUT utilization shows a consumption of 151,200 units for the BCU and 140,000 units for the FCU, translating to 30% and 27.78% of the total available LUTs, respectively. Similarly, memory usage is detailed with the BCU utilizing 11.4 MB and the FCU utilizing 10.5 MB, equating to 30% and 27.63% of the total available memory. The IO resource shows a utilization of 139 and 130 for the BCU and FCU, corresponding to 29.19% and 28.02% of the total IOs available. Lastly, DSP resource usage is listed as 518 for the BCU and 480 for the FCU, amounting to 29.94% and 27.78% of the total DSPs, respectively.

TABLE II
COMPARATIVE ANALYSIS OF FCU AND
BCU BASED ON PERFORMANCE METRICS.

| Performance Metrics | FCU | BCU |
|---|---|---|
| Accuracy (%) | 86.5 | 88.0 |
| MAC (GOP) | 1.2 | 1.35 |
| Latency [ms] | 15 | 12 |
| Power Efficiency | 18.5 GOP/s/W | 20.0 GOP/s/W |

*Accuracy is measured as a percentage of correct predictions.
*MAC (GOP) refers to the number of Multiply-Accumulate operations in Giga Operations.
*Latency is measured in milliseconds and indicates the response time of the system.
*Power Efficiency is assessed in terms of energy efficiency during operations.

Table II shows into a detailed comparative analysis between the FCU and BCU based on several critical performance metrics. This comparison elucidates the operational differences and relative strengths of each unit within our framework. Firstly, we observe that the BCU demonstrates a slightly higher accuracy (88.0%) compared to the FCU (86.5%). This margin, although narrow, highlights the BCU's enhanced capability in correctly interpreting and processing the data it receives. The increased accuracy of the BCU can be attributed to its more sophisticated algorithmic structure which is inspired by the intricate workings of the human brain. Moving on to the MAC (Multiply-Accumulate) operations, the BCU registers 1.35 Giga Operations, a slight elevation over the FCU's 1.2 GOP. This increment in MAC operations for the BCU is indicative of its more complex computational framework, which, while increasing its computational load, also enhances its processing capability. The latency metric is especially telling in this comparison. The FCU exhibits a latency of 15 milliseconds, which is higher than the BCU's 12 milliseconds. This difference underscores the BCU's efficiency in processing data in a timely manner, a crucial aspect for real-time applications. Finally, the power efficiency of both units is compared. The BCU, with 20.0 GOP/s/W, shows a higher efficiency compared to the FCU's 18.5 GOP/s/W. This demonstrates the BCU's ability to perform more operations per watt, making it a more energy-efficient choice, especially for applications where power consumption is a critical factor. The comparative analysis between FCU and BCU in our framework illustrates the differences in their design and operational efficiency. While both units have their unique strengths, the BCU shows a slight edge in terms of accuracy, MAC operations, latency, and power efficiency, making it a more optimal choice for certain applications that demand higher performance and efficiency.

Effectiveness of Mixed-Signal Design. The integration of analog and digital components in Mixed-signal design brings together the best of both worlds: the precision and scalability of digital systems with the nuanced and varied processing of analog systems. This subsection delves into how mixed-signal design augments system performance, with a focus on its impact on energy efficiency and processing speed. We compare the chip area, latency, and energy efficiency (EE) of a traditional digital CMOS design against our mixed-signal implementation that shows in Table III.

TABLE III
EFFECTIVENESS OF DIGITAL CMOS
VS. MIXED-SIGNAL DESIGN

| | Chip area | Latency | EE |
|---|---|---|---|
| Design Type | (mm2) | (ms) | (TOPS/W) |
| Digital CMOS | 321 | 12 | 0.28 |
| Mixed-Signal | 293 | 0.75 | 213 |

*The energy efficiency (EE) is represented in tera-operations per second per watt (TOPS/W), which is a standard metric for such evaluations.

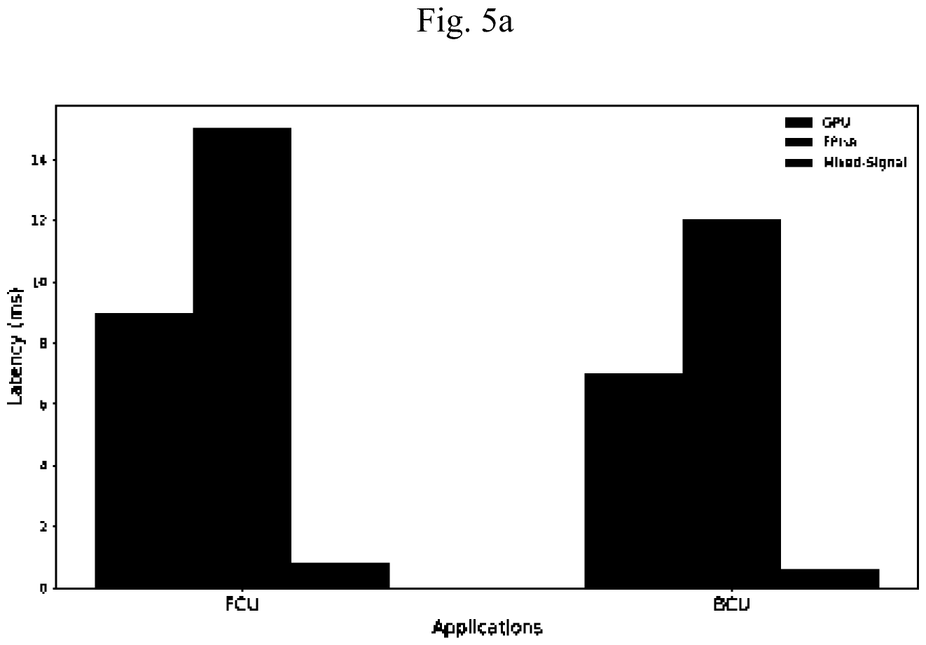

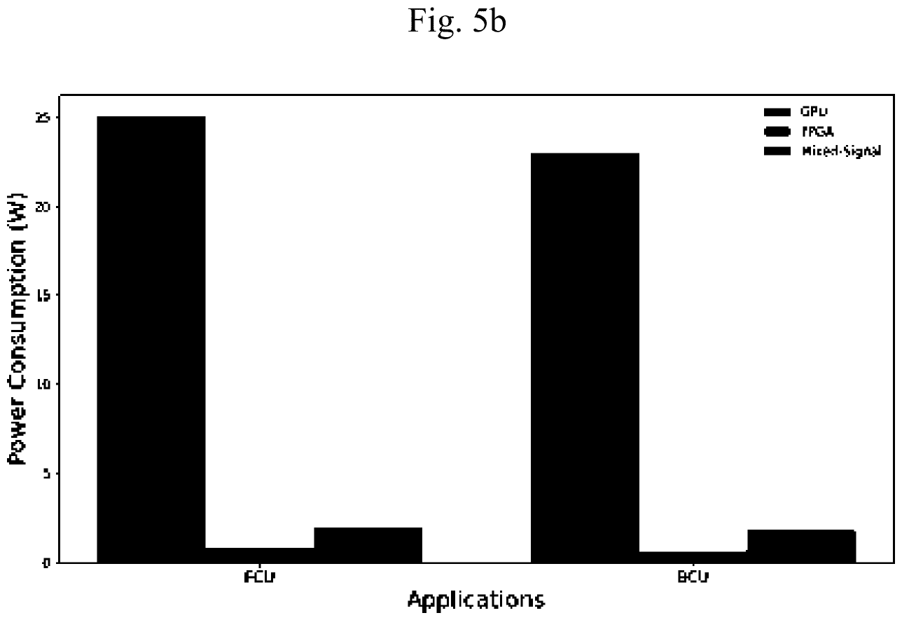

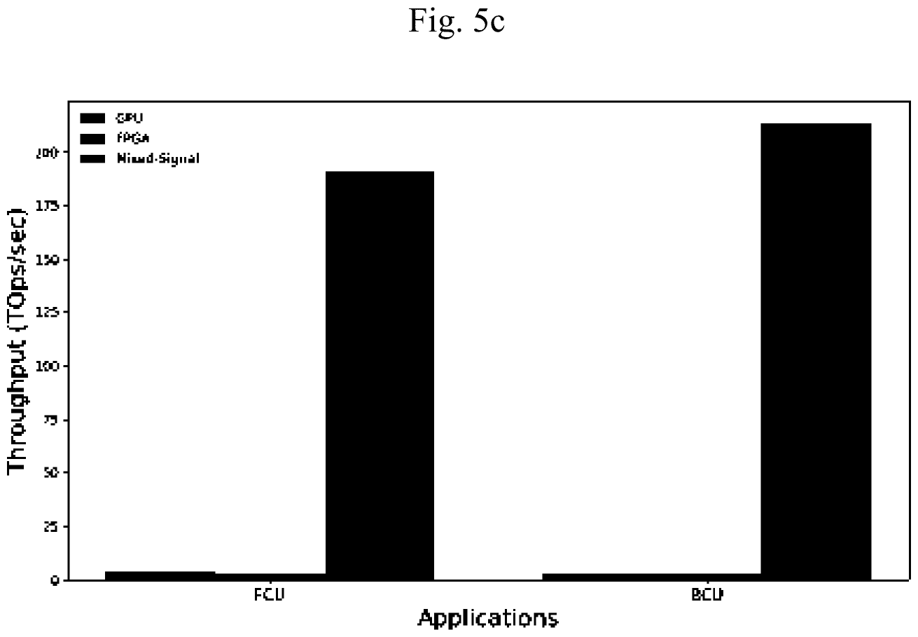

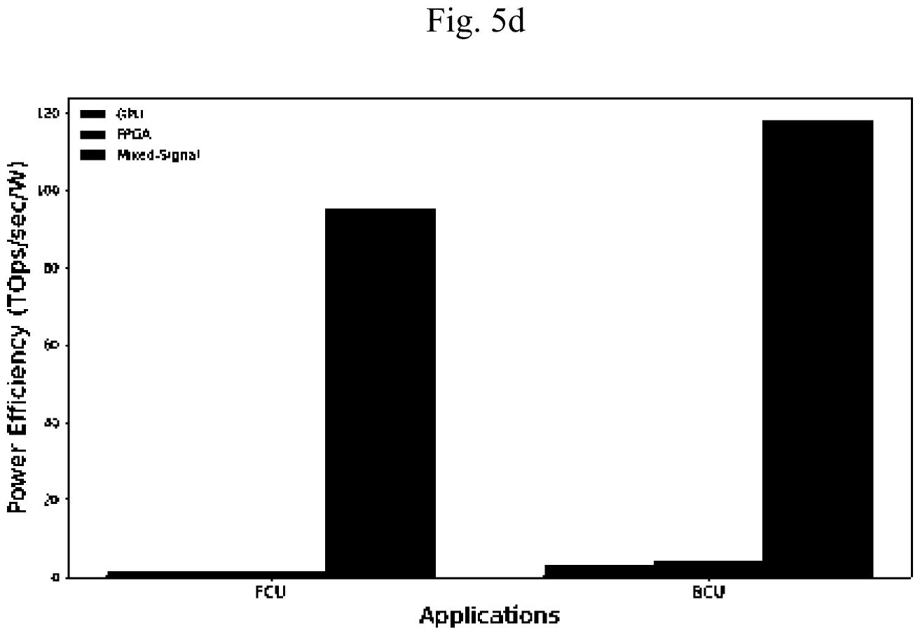

FIGS. 5a, 5b, 5c, and 5d illustrate a comparison of key metrics such as latency (FIG. 5a), power consumption (FIG. 5b), throughput (FIG. 5c), and power efficiency (FIG. 5d) across different computational platforms: GPU, FPGA, and Mixed-Signal. This comparison is conducted for both the FCU and BCU applications. The latency analysis reveals that the FPGA platform exhibits lower latency values for both FCU and BCU, suggesting its efficiency in rapid data processing. In contrast, the GPU shows relatively higher latency, while the Mixed-Signal design achieves the lowest latency values, underscoring its potential in real-time processing applications. The FPGA platform demonstrates a significantly lower power requirement compared to the GPU, making it a more energy-efficient choice. However, the Mixed-Signal design outperforms both FPGA and GPU in terms of energy consumption, indicating its suitability for power-sensitive applications. The Mixed-Signal design achieves the highest throughput for both FCU and BCU, followed by the GPU and then FPGA. This highlights the Mixed-Signal design's superior processing capability. The power efficiency analysis demonstrates that the Mixed-Signal platform provides the highest power efficiency, followed by FPGA and GPU. This metric is crucial for understanding the overall energy effectiveness of each platform in executing high-performance tasks.

CONCLUSIONS. This research marks a significant milestone in the development of neuromorphic computing systems, as it encapsulates the successful integration and implementation of BCUs and FCUs within a digital neuromorphic architecture. The primary findings of this study highlight remarkable improvements in computational efficiency and accuracy, primarily attributed to the innovative mixed-signal design approach. Our experimental investigations, conducted using diverse open-source datasets, have validated the superior performance capabilities of our neuromorphic system. This encompasses processing speed, energy efficiency, and adaptability, which are notably more advanced than those observed in traditional neuromorphic systems. The data reveal that each computational platform GPU, FPGA, and Mixed-Signal-exhibits unique strengths. However, it is the Mixed-Signal design that stands out, offering an exceptional balance of low latency, high throughput, and extraordinary power efficiency. This makes it a compelling choice for a wide array of applications, especially those demanding high efficiency and adaptability. The importance of the mixed-signal neuromorphic systems, as demonstrated by our research, lies in their capacity to effectively bridge the robustness of analog processing with the precision and scalability of digital systems. This study has evidenced that such systems are not just feasible but also excel in certain computational tasks, particularly where high efficiency and flexibility are paramount. The utilization of mixed-signal design has emerged as a pivotal innovation in neuromorphic computing, paving the way for more sophisticated, efficient, and versatile computing solutions.

Embodiments may include, for example, taking the output of the chip shown in the GDSII flow and creating a sensor fusion acceleration that includes multiple sensors along with the models here, and running these sensors in IoT with a brain-inspired chip. Our research has opened new avenues in the field of Mixed-signal neuromorphic computing, particularly highlighting its potential in advanced computational models. Based on our findings, the following are proposed directions for further research:

Embodiments may include, for example, sophisticated methods for integrating BCU and FCU into mixed-signal neuromorphic architectures. This could involve algorithms or hardware configurations that further enhance the efficiency and scalability of these systems. ⋅ Diverse Application Scenarios: Extending the application of our mixed-signal neuromorphic architecture to a broader range of fields, such as robotics, autonomous systems, and complex data analysis. This would help in understanding the versatility and adaptability of our architecture in different scenarios.

Embodiments may include, for example, materials and circuit designs that could further reduce the power consumption of neuromorphic systems. This is crucial for developing sustainable and eco-friendly computing technologies.

Embodiments may include, for example, real-time data processing capabilities in dynamic environments. This includes enhancing the system's ability to adapt and learn from new data in real-time, which is vital for applications in areas like autonomous driving and interactive systems.

Embodiments may include, for example, long-term improvements of mixed-signal neuromorphic systems. This would involve assessing the durability and maintenance needs of these systems over extended periods, which is critical for their practical deployment.

Embodiments may include, for example, benchmarking the performance of mixed-signal neuromorphic systems against emerging technologies. This comparison could provide valuable insights into the strengths and limitations of each approach.

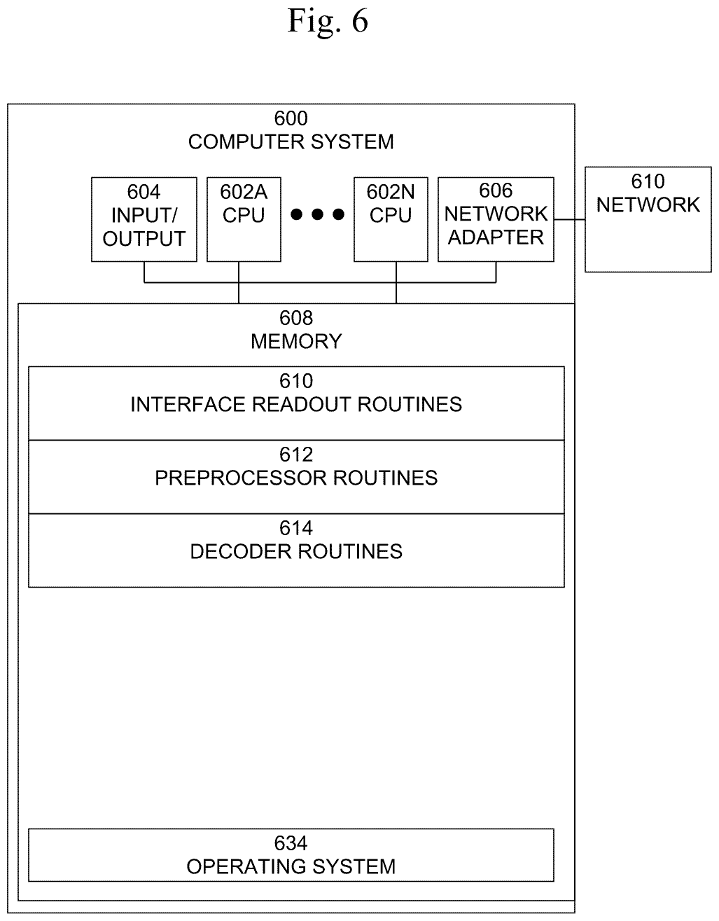

An exemplary block diagram of a computer system 600, in which processes involved in the embodiments described herein may be implemented, is shown in FIG. 6. Computer system 600 may be implemented using one or more programmed general-purpose computer systems, such as embedded processors, systems on a chip, personal computers, workstations, server systems, and minicomputers or mainframe computers, or in distributed, networked computing environments. Computer system 600 may include one or more processors (CPUs) 602A-602N, input/output circuitry 604, network adapter 606, and memory 608. CPUs 602A-602N execute program instructions in order to carry out the functions of the present communications systems and methods. Typically, CPUs 602A-602N are one or more microprocessors, such as an INTEL CORE® processor. FIG. 6 illustrates an embodiment in which computer system 600 is implemented as a single multi-processor computer system, in which multiple processors 602A-602N share system resources, such as memory 608, input/output circuitry 604, and network adapter 606. However, the present communications systems and methods also include embodiments in which computer system 600 is implemented as a plurality of networked computer systems, which may be single-processor computer systems, multi-processor computer systems, or a mix thereof.

Input/output circuitry 604 provides the capability to input data to, or output data from, computer system 600. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 606 interfaces device 600 with a network 610. Network 610 may be any public or proprietary LAN or WAN, including, but not limited to the Internet.

Memory 608 stores program instructions that are executed by, and data that are used and processed by, CPU 602 to perform the functions of computer system 600. Memory 608 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 608 may vary depending upon the function that computer system 600 is programmed to perform. In the example shown in FIG. 6, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present communications systems and methods may include any and all such arrangements.

In the example shown in FIG. 6, memory 608 may include interface readout routines 610, preprocessor routines 612, decoder routines 614, and operating system 634. Interface readout routines 610 may include software to perform recording and transmission of signals 416 received from sensors 402, as described above. Preprocessor routines 612 may include software to perform may perform analysis of neural spike waveforms, as described above. Decoder routines 614 may include software to perform advanced stages of signal conditioning and interpretation, as described above. Operating system routines 622 may provide overall system functionality.

As shown in FIG. 6, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method to perform computing functions that mimic at least one computing function of a human brain comprising:
performing signal processing of neural signals obtained from living brain tissue using at least one sensor using analog circuitry;
processing the obtained neural signals to generate a representation of a brain function from the obtained neural signals, and to generate parameters for use by analog and digital circuitry to perform computing functions that mimic at least one computing function of a human brain using a computer system comprising a processor, memory accessible by the processor, and computer program instructions stored in the memory and executable by the processor digital circuitry and software configured to process the obtained neural signals to generate a representation of a brain function from the obtained neural signals, and to generate parameters for use by analog and digital circuitry to perform computing functions that mimic at least one computing function of a human brain; and
using the generated parameters to perform, using analog and digital circuitry, computing functions that mimic at least one computing function of a human brain.

2. The method of claim 1, wherein the analog and digital circuitry is configured to perform computing functions using Brain Code Units and Fundamental Code Units.

3. The method of claim 2, further comprising processing the obtained neural signals to generate a representation of a brain function from the obtained neural signals, and to generate parameters for use by analog and digital circuitry to perform computing functions that mimic at least one computing function of a human brain using Image and Audio data, Disorder Signature data, and Neuroscience Expression data.

4. The method of claim 3, further comprising using the generated parameters to perform, using analog and digital circuitry, computing functions that mimic at least one computing function of a human brain using Image and Audio data, Disorder Signature data, and Neuroscience Expression data.

5. A system comprising:
hardware and software configured to perform computing functions that mimic at least one computing function of a human brain, wherein the hardware and software comprises:
analog circuitry configured to perform signal processing of neural signals obtained from living brain tissue using at least one sensor;
a computer system comprising a processor, memory accessible by the processor, and computer program instructions stored in the memory and executable by the processor digital circuitry and software configured to process the obtained neural signals to generate a representation of a brain function from the obtained neural signals, and to generate parameters for use by analog and digital circuitry to perform computing functions that mimic at least one computing function of a human brain; and
the analog and digital circuitry configured to use the generated parameters to perform computing functions that mimic at least one computing function of a human brain.

6. The system of claim 5, wherein the analog and digital circuitry is configured to perform computing functions using Brain Code Units and Fundamental Code Units.

7. The system of claim 6, wherein processing the obtained neural signals to generate a representation of a brain function from the obtained neural signals, and to generate parameters for use by analog and digital circuitry to perform computing functions that mimic at least one computing function of a human brain using Image and Audio data, Disorder Signature data, and Neuroscience Expression data.

8. The system of claim 7, wherein using the generated parameters to perform, using analog and digital circuitry, computing functions that mimic at least one computing function of a human brain using Image and Audio data, Disorder Signature data, and Neuroscience Expression data.
